(19) United States
(12) Patent Application Publication
(10) Pub. No.: US 2015/0377192 A1
(43) Pub. Date: Dec. 31, 2015

(54) EXHAUST EJECTOR TUBE FOR ENGINE SYSTEM

(71) Applicant: Caterpillar Inc., Peoria, IL (US)

(72) Inventors: Subhro Samarendra NATHAK, Peoria, IL (US); Chris J. SCOLTON, III, Edelstein, IL (US); Tyler Jay WILLIAMS, East Peoria, IL (US); Andrew Paul GREIF, Geneva, IL (US)

(73) Assignee: Caterpillar Inc.

(21) Appl. No.: 14/319,487

(22) Filed: Jun. 30, 2014

(51) Int. Cl. F02M 35/08; F02M 35/024

(52) U.S. Cl. CPC F02M 35/082; F02M 35/024

(57) ABSTRACT

An exhaust ejector tube is disclosed for use with an engine system. The exhaust ejector tube may have an exhaust pipe with an upstream end, a downstream end, and a plurality of flutes formed at the downstream end. Each of the plurality of flutes may have a rounded end that tapers toward the downstream end. The downstream end of the exhaust pipe terminates partway along a length of the plurality of flutes. The exhaust ejector tube may also have an ejector pipe with a smaller diameter than the exhaust pipe that intersects with the exhaust pipe. The second ejector pipe may have an upstream end located outside the exhaust pipe, and a downstream end located inside the exhaust pipe at the plurality of flutes.

### TECHNICAL FIELD

The present disclosure is directed to an ejector tube and, more particularly, to an exhaust ejector tube for an engine system.

### BACKGROUND

Machines used in the farming, construction, mining, power generation, and other like industries commonly operate in harsh environments characterized by large amounts of airborne debris. In such environments, it is desirable to remove the debris from the air before directing the air into an engine of the associated machine. To assist with this process, a machine will typically include a debris separator or pre-cleaner that is located upstream of a higher-efficiency filter. The pre-cleaner is designed to separate larger particles from the air before the air flows through the filter, thereby extending a life of the filter.

Over time, the particles can build up in the pre-cleaner and, if not removed, can reduce an efficiency of the pre-cleaner. In some applications, the pre-cleaner is continuously evacuated of the collected particles. Specifically, a conduit extends from the pre-cleaner to an exhaust passage of the engine at a location of restricted flow. The restriction placed on the exhaust flow causes the exhaust velocity to increase and thereby generate a low-pressure region at an outlet of the conduit. The low pressure evacuates the collected particles away from the pre-cleaner and into the exhaust flow, thereby ensuring continued efficient operation of the pre-cleaner. The exhaust flow, now containing the particles, is then discharged to the atmosphere.

An exemplary pre-cleaner system is disclosed in an Exhaust Product Guide published by Donaldson Filtration Solutions in 2012. The pre-cleaner receives a flow of ambient air and particles, and removes the particles from the air. The air is then sent through a filter to an engine, while the particles (along with scavenge air) are directed through a check valve to an ejector tube located in an exhaust flow path. The exhaust ejector tube includes three flutes radially arranged around a distal end located away from an inlet port. The three flutes restrict exhaust flow, thereby increasing a velocity of the exhaust stream and simultaneously reducing a static pressure of the exhaust stream. An elbow extends from the inlet port to a center of the exhaust ejector tube terminating at a downstream end of the flutes. In this configuration, the low pressure at an open end of the elbow draws particles into the exhaust flow for ejection to the atmosphere. The exhaust ejector tube is configured to extend through an engine enclosure and is covered at its distal end with a stack cap.

While the system disclosed in the Exhaust Product Guide may be successful at removing collected particles from the pre-cleaner and ejecting them to the atmosphere, it may also be problematic in some applications. In particular, in some applications, the exhaust ejector tube must work together with an existing engine enclosure, existing exhaust passages, and an existing engine enclosure exhaust stack to scavenge the enclosure of heat and combustion gases without generating excessive noise. And the system shown in the Exhaust Product Guide may not be capable of providing this functionality.

The disclosed exhaust ejector tube and engine system are directed toward overcoming one or more of the problems set forth above and/or other problems of the prior art.

### SUMMARY

One aspect of the present disclosure is directed to an exhaust ejector tube. The exhaust ejector tube may include an exhaust pipe with an upstream end, a downstream end, and a plurality of flutes formed at the downstream end. Each of the plurality of flutes may have a rounded end that tapers toward the downstream end. The downstream end of the exhaust pipe terminates partway along a length of the plurality of flutes. The exhaust ejector tube may also include an ejector pipe with a smaller diameter than the exhaust pipe that intersects with the exhaust pipe. The ejector pipe may have an upstream end located outside the exhaust pipe, and a downstream end located inside the exhaust pipe at the plurality of flutes.

Another aspect of the present disclosure is directed to an engine system associated with an engine disposed in an enclosure. The engine system may include a pre-cleaner having an inlet, a main outlet configured to communicate with the engine, and a particle outlet. The engine system may also include an engine enclosure exhaust stack open to the enclosure, and an exhaust ejector tube. The exhaust ejector tube may have an exhaust pipe with an upstream end configured to connect to the engine and a downstream end that extends a distance into the engine enclosure exhaust stack. The downstream end may be annularly spaced apart from the engine enclosure exhaust stack such that a gap exists therebetween. The distance that the downstream end of the exhaust pipe of the exhaust ejector tube extends into the engine enclosure exhaust stack may be about equal to a diameter of the exhaust pipe. The exhaust ejector tube may also have an ejector pipe with a smaller diameter than the exhaust pipe that intersects with the exhaust pipe. The gap may be about equal to a diameter of the ejector pipe. The engine system may further include a conduit that extends from the pre-cleaner to the ejector pipe of the exhaust ejector tube.

Another aspect of the present disclosure is directed to a machine. The machine may include a frame, an engine supported by the frame, and an enclosure supported by the frame and configured to house the engine. The machine may further include a pre-cleaner extending through the enclosure and having an inlet configured to draw in air and debris from the atmosphere, a first outlet configured to direct a main flow of air to the engine, and a second outlet configured to discharge a scavenge flow of air and debris. The machine may also include an engine enclosure exhaust stack connected to the enclosure and configured to receive enclosure air, exhaust, scavenge air and debris, and an exhaust ejector tube. The exhaust ejector tube may have an upstream end connected to receive exhaust from the engine, a downstream end free floating a distance inside the engine enclosure exhaust stack and annularly spaced apart from walls of the engine enclosure exhaust stack by a gap, and a particle inlet configured to receive scavenge air and debris from the second outlet of the pre-cleaner. The exhaust ejector tube may also have a plurality of flutes located at the downstream end and configured to restrict a flow of exhaust from the upstream end to the downstream end. The downstream end may terminate at a location partway along a length of the flutes.

### BRIEF DESCRIPTION OF THE DRAWINGS

FIG. 1 is an isometric illustration of an exemplary disclosed machine;

FIG. 2 is an isometric illustration of an engine system that may be used in conjunction with the machine of FIG. 1; and

FIGS. 3 and 4 are isometric illustrations of an exemplary exhaust ejector tube that may form a portion of the engine system of FIG. 2.

### DETAILED DESCRIPTION

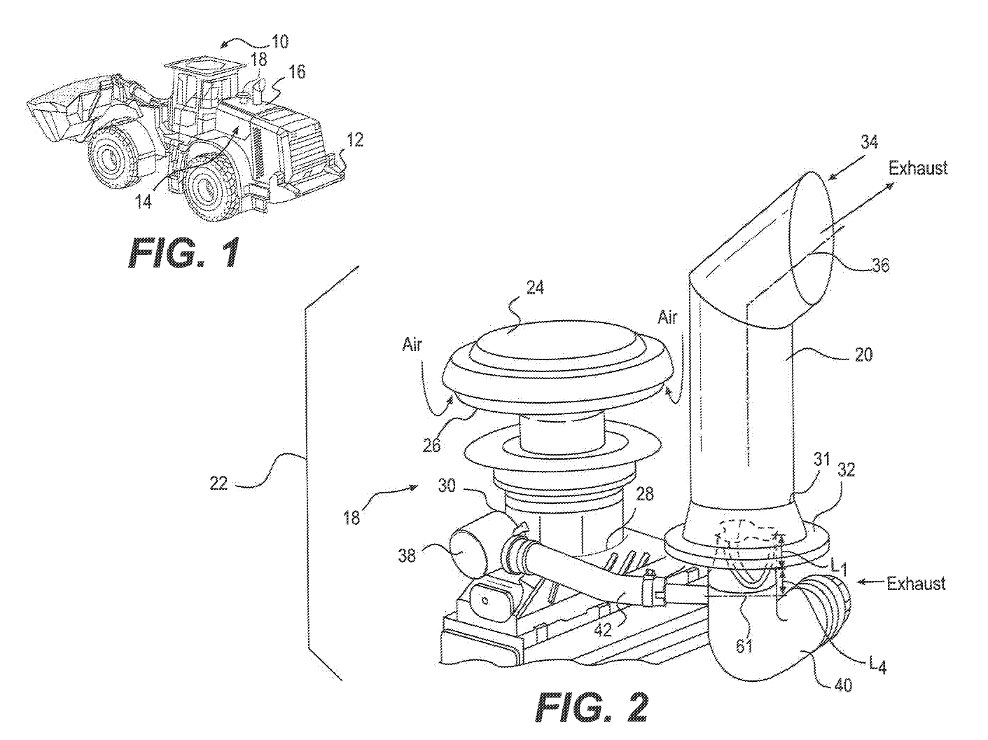

FIG. 1 illustrates an exemplary embodiment of a machine 10. Machine 10 may be mobile or stationary, and configured to perform some type of operation associated with an industry such as construction, agriculture, mining, long-haul transportation, power generation, or another industry known in the art. For example, machine 10 may be a wheel loader (shown in FIG. 1), a dump truck, a dozer, an excavator, an off-highway truck, or another similar vehicle. Alternatively, machine 10 could be associated with a stationary power plant or a pumping operation. In the example of FIG. 1, machine 10 includes a frame 12 that supports an engine 14 inside an enclosure 16. Combustion air, along with airborne particles (e.g., dust, dirt, and other debris), may be drawn into enclosure 16 from the atmosphere via a pre-cleaner 18, and exhaust, heat, and some of the airborne particles may be ejected from enclosure 16 back into the atmosphere via an engine enclosure exhaust stack (“exhaust stack”) 20.

As shown in FIG. 2, pre-cleaner 18 and exhaust stack 20 may form a portion of an engine system 22 associated with engine 14. In particular, pre-cleaner 18 may be located within an air induction system that directs clean air into engine 14, and exhaust stack 20 may be located within an exhaust system that discharges exhaust from engine 14 to the atmosphere. As will be described in more detail below, engine system 22 may connect pre-cleaner 18 to exhaust stack 20, such that some of the particles collected by pre-cleaner 18 may be passed to exhaust stack 20.

Pre-cleaner 18 may embody any conventional pre-cleaner known in the art. In the disclosed example, pre-cleaner 18 includes a housing 24 forming an inlet 26, a main outlet 28, and a particle outlet 30; and a separator (e.g., baffles, fins, meshes, screens, vanes, etc.—not shown) located within housing 24 between inlet 26 and the main and particle outlets 28, 30. Inlet 26 may be, for example, an annular opening located under the periphery of a rain cover and configured to allow air into housing 24 from all angles. In one example, a screen or perforated plate (not shown) may be located at inlet 26 to inhibit the ingress of large debris (e.g., leaves, sticks, garbage, etc.). After entering housing 24 via inlet 26, the air may pass through the separator, where heavier particles entrained within the air become blocked or otherwise trapped within a collection area. The heavier particles may then fall toward a bottom of housing 24, while the air passes inward to a center axis of pre-cleaner 18 and flows downward out of pre-cleaner 18 and into engine 14 via main outlet 28.

Exhaust stack 20 may embody a hollow tube that flares out at a transition point 31 to a base end 32 at enclosure 16 (referring to FIG. 1). In one embodiment, exhaust stack 20 is bent rearward (cut and welded at a tilted position relative to a normal travel direction of machine 10) through an angle of about 450, and an opening at an exit end 34 is oriented downward at an angle of about 45° relative to a central axis 36 such that the opening is generally elliptical in shape. This bend, in connection with the downward orientation, may function to redirect exhaust from engine 14 through about 900 and thereby help limit an amount of moisture that can enter enclosure 16 when engine 14 is turned off (i.e., when a pressure within exhaust stack 20 is reduced to atmospheric pressure). Exhaust stack 20 may be open to enclosure 16, and function to direct exhaust, collected particles, and heat out of enclosure 16.

Engine system 22 may include components that cooperate to connect the collection area of pre-cleaner 18 to base end 32 of exhaust stack 20. In particular, engine system 22 may include one or more scavenge ports (not shown) joining the collection area of pre-cleaner 18 to particle outlet 30, a valve (e.g., a check valve) 38 located at particle outlet 30, an exhaust ejector tube 40, and a conduit 42 that extends from valve 38 to exhaust ejector tube 40. Valve 38 may be configured to ensure a unidirectional flow of scavenge air and particles through conduit 42. Exhaust ejector tube 40 may be configured to receive a flow of exhaust from engine 14 and the scavenge flow from pre-cleaner 18, and to direct a combined flow of exhaust, scavenge air, and particles into exhaust stack 20. As shown in FIG. 2, exhaust ejector tube 40 may extend a distance L₁ into base end 32 of exhaust stack 20. This distance, in combination with an annular spacing between exhaust ejector tube 40 and exhaust stack 20 (explained in more detail below), may provide for a desired flow rate of hot air from enclosure 16 out through exhaust stack 20 and an overall noise level of the combined gases (enclosure air, scavenge air, and exhaust) flows.

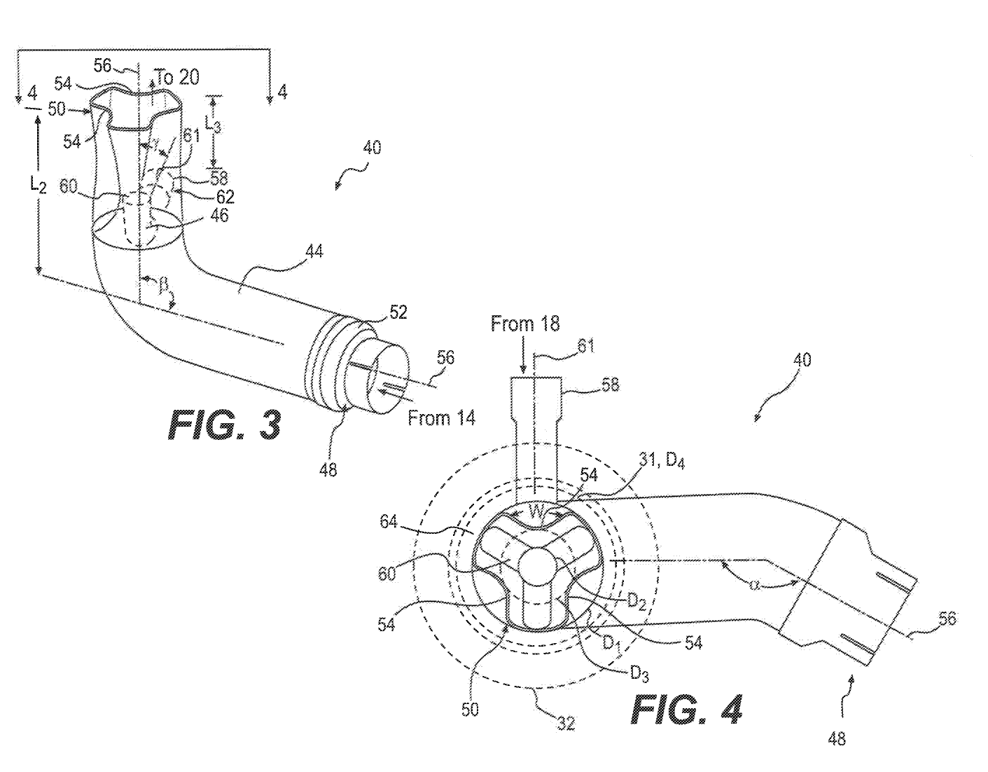

An exemplary embodiment of exhaust ejector tube 40 is shown in FIGS. 3 and 4. In this embodiment, exhaust ejector tube 40 may be an assembly of at least two different components. Specifically, exhaust ejector tube 40 may include an exhaust pipe 44 and an ejector pipe 46 that are welded, press-fit, mechanically fastened, or otherwise joined together. It is contemplated that other support features, such as gussets, brackets, sensor mounts, etc. (not shown) could be associated with either one or both of pipes 44, 46, if desired.

Exhaust pipe 44 may have a diameter D₁ of about 3-6 inches, and extend from an upstream end 48 to a downstream end 50. Upstream end 48 may be configured to connect with the exhaust system of engine 14 (e.g., with an after treatment device, a main exhaust conduit, an exhaust manifold, a turbine, or another exhaust system component), while downstream end 50 may extend into base end 32 of exhaust stack 20. Exhaust pipe 44 may include an adapter (e.g., a reducer) 52 or another type of coupling at upstream end 48. Downstream end 50 may be free floating within exhaust stack 20.

In the disclosed example, exhaust pipe 44 includes two bends and has the general shape of an elbow. In particular, as shown in FIG. 4, exhaust pipe 44 may bend through an oblique angle α (e.g., of about 135°) in a first or horizontal plane at a location adjacent upstream end 48, and bend through an angle β of about 90° in a second or vertical plane at an intermediate location. With this configuration, exhaust may enter exhaust pipe 44 in the horizontal plane, and exit exhaust pipe 44 in the vertical plane. It is contemplated, however, that exhaust pipe 44 could be straight or contain a different number of bends at different angles, if desired.

A plurality of flutes 54 may be formed within exhaust pipe 44 at downstream end 50. Each flute 54 may be an elongated depression that is generally aligned with a central axis 56 of ejector pipe 44. In the disclosed embodiment, exhaust pipe 44 includes three flutes 54 that are spaced at substantially equal intervals around central axis 56, although any number of flutes 54 and any angular spacing may be possible. Each flute 54 may have a rounded base, with a width W that taper towards downstream end 50 (e.g., in a teardrop shape). In addition, each flute 54 may protrude inward toward central axis 56 by a greater amount at the rounded base, such that ejector pipe 44 is restricted to an inner diameter D₂ less than D₁ at flutes 54. At locations between adjacent flutes 54, the diameter of exhaust pipe 44 may increase (but still be less than D₁), such that a cross-section of exhaust pipe 44 at flutes 54 has a general Y-shape. In this configuration, a cross-sectional flow area of exhaust pipe 44 may be reduced at flutes 54 by about 30-50% compared to a section of exhaust pipe 44 upstream of flutes 54.

Downstream end 50 may terminate at a location partway along a length of flutes 54. That is, flutes 54 may be cut off (e.g., flutes 54 may not come to a point), such that downstream end 50 is still restricted somewhat when compared to sections of exhaust pipe 44 located upstream of flutes 54. This restriction, however, may be less than at the rounded base end of flutes 54. In one embodiment, an inner diameter D₃ of flutes 54 at downstream end 50 may be about halfway between D₁ and D₂ (e.g., D₃≈(D₁+D₂)/2). As will be described in more detail below, this configuration, in conjunction with other dimensions and shapes of exhaust ejector tube 40 yet to be described, may provide for a desired flow and/or noise profile of engine system 22.

Ejector pipe 46 may pass through a wall of exhaust pipe 44 at an intermediate location, thereby combining the flow of scavenge air and particles from pre-cleaner 18 with the flow of exhaust passing through ejector pipe 44. Ejector pipe 46 may have a diameter about equal to the diameter D₂ of ejector pipe 44 at flutes 54. In one example, D₂ may be about equal to 0.25-0.375 times D₁ (e.g., D₂ may be about 1-2.5 inches). Ejector pipe 46 may comprise an upstream end 58 configured to connect with conduit 42 (referring to FIG. 2), and a downstream end 60 that extends into ejector pipe 44. Ejector pipe 46 may also include an adapter (e.g., a flare) 62 or other type of coupling at upstream end 58. Downstream end 60 may be held by, welded to, or otherwise positioned at flutes 54.

In the disclosed example, ejector pipe 46 includes one bend and has the general shape of an elbow. In particular, as shown in FIG. 3, ejector pipe 46 may bend through an angle γ (e.g., of about 90°) in the vertical plane at an intermediate location. With this configuration, scavenge air and particles may enter ejector pipe 46 in the horizontal direction (i.e., in a direction substantially perpendicular to central axis 36 of exhaust stack 20), and exit ejector pipe 46 in the vertical direction in general alignment with central axis 36 of exhaust stack 20. It is contemplated, however, that ejector pipe 46 could be straight or contain a different number of bends at different angles, if desired.

The inlet axial location of ejector pipe 46 at upstream end 58, relative to the axial termination point of exhaust pipe 44 at downstream end 50, in combination with a terminal location point of downstream end 60 at flutes 54 and the restriction provided by flutes 54, may affect the flow and noise profiles discussed above. In one embodiment, downstream end 50 of exhaust pipe 44 may terminate at a distance L₂ from central axis 56, when measured at upstream end 48. In this same embodiment, a central axis 61 of ejector pipe 46 at an intersection location with exhaust pipe 44 may be located a distance L₃ from downstream end 50 of exhaust pipe 44. In addition, central axis 61 of ejector pipe 46 at the intersection location of exhaust pipe 44 may be located an axial distance L₄ from base end 32 of exhaust stack 20, such that downstream end 50 of exhaust pipe 44 is within about 40-60% of transition point 31 of the flare on base end 32 of exhaust stack 20 (referring to FIG. 2). In one example, L₄ may be less than L₃, which may be less than L₂ (i.e., L₄<L₃<L₂). Specifically, L₂ may be about 11.5-12 inches; L₃ may be about 5.75-7.75 inches; and L₄ may be about to the diameter D₁ (e.g., about 3-6 inches). In this configuration, L₂ may be about three times greater than D₁, and L₃ may be about 1.75 times greater than D₁. It has been found that a shorter exhaust ejector tube 40 may result in too little scavenge air/debris flow into exhaust ejector tube 40, while a longer exhaust ejector tube 40 may result in increased sound and/or reduced enclosure air flow through exhaust stack 20.

The location and relative sizing of exhaust pipe 44 within exhaust stack 20 may also have an effect on the flow and noise profile of exhaust system 22. As shown in FIG. 4, exhaust stack 20 may have an inner diameter D₄ that is larger than the outer diameter D₁ of exhaust pipe 44 at downstream end 58, such that an annular gap 64 exists therebetween (i.e., gap 64≈(D₄−D₁)/2). In one embodiment, gap 64 may be less than about one-half of D₁ (e.g., gap 64≦D₁/2≈2-3 inches).

### INDUSTRIAL APPLICABILITY

The engine system of the present disclosure may have wide application in a variety of machine types including, for example, machines employed in mining, construction, agriculture, and power generation applications. The disclosed engine system finds particular applicability in machines operating in environments characterized by high levels of airborne dust, dirt, and other debris. By equipping or retrofitting machines with the engine system of the present disclosure, damage to various components of such machines may be reduced and the operational efficiency of such machines may be improved. In addition, the resulting noise produced by these machines may be low, allowing operation in regulated jobsites or work zones. Operation of engine system 22 will now be described in detail with respect to FIGS. 2-4.

During operation of machine 10, air and debris from the atmosphere may be drawn into pre-cleaner 18 through combustion processes occurring inside engine 14. In particular, engine 14 may consume the air and thereby create a low-pressure region within pre-cleaner 18 that draws in additional air and debris. As the air and debris enters pre-cleaner 18, larger particles of the debris may be blocked, allowing only air entrained with smaller particles to pass through to the separator. The separator may then divide the incoming flow of air and debris into a main flow of relatively cleaner air and a smaller flow of relatively debris-dense scavenge air. The main flow of air may be directed through additional filters before entering and being consumed by engine 14. The smaller flow of scavenge air may pass through valve 38 and conduit 42 to ejector pipe 46 of exhaust ejector tube 40. At this same time, the exhaust generated by engine 14 may enter exhaust pipe 44 of exhaust ejector tube 40.

As the exhaust passes from upstream end 48 of exhaust pipe 44 to downstream end 50, the exhaust may flow through the section of exhaust pipe 44 having flutes 54. As described above, flutes 54 may decrease a cross-sectional flow area at this location, thereby placing a restriction on the flow of exhaust. This restriction may cause the exhaust flow to speed up at this location, resulting in a region of low-pressure at downstream end 60 of ejector pipe 46. The pressure at downstream end 60, being lower than the pressure at upstream 58, may generate flow within ejector pipe 46 and conduit 42 that draws the scavenge air and associated smaller debris particles from pre-cleaner 18 into exhaust ejector tube 40.

As the exhaust flow (now combined with scavenge air and debris) exits exhaust ejector tube 40 and flows into exhaust stack 20, the flow of air may expand into the larger diameter ejector pipe. This expansion may generate another region of low-pressure within gap 64 and, when combined with a slightly higher-than-atmospheric pressure inside enclosure 16 (referring to FIG. 1—elevated pressure caused by engine heat), may generate flow from enclosure 16 through exhaust stack 20. In other words, a combined flow of exhaust, scavenge air, debris, and enclosure air may exit machine 10 via exhaust stack 20, and the unique dimensional relationships (diametral and axial locational relationships) of exhaust ejector tube 40 and exhaust stack 20 may provide for this flow.

In addition to the disclosed arrangement of exhaust pipe 44, ejector pipe 46, and exhaust stack 20 creating the above-described low-pressure regions that promote the flow of scavenge and enclosure air, the arrangement may also help to reduce noises levels of the different flows. In particular, the termination location of exhaust ejector tube 40 at downstream end 50, relative to the location of flutes 54, central axis 56, downstream end 60, central axis 61, transition point 31 and base 32 of exhaust stack 20 may provide a unique flow velocity and selective attenuation that produces low levels of noise.

It will be apparent to those skilled in the art that various modifications and variations can be made to the engine system without departing from the scope of the disclosure. Other embodiments will be apparent to those skilled in the art from consideration of the specification and practice of the engine system disclosed herein. It is intended that the specification and examples be considered as exemplary only, with a true scope of the disclosure being indicated by the following claims and their equivalents.

What is claimed is:

1. An exhaust ejector tube, comprising:
an exhaust pipe having an upstream end, a downstream end, and a plurality of flutes formed at the downstream end, wherein:
each of the plurality of flutes have a rounded end that tapers toward the downstream end; and
the downstream end of the exhaust pipe terminates partway along a length of the plurality of flutes; and
an ejector pipe that intersects with the exhaust pipe, the ejector pipe having a smaller diameter, an upstream end located outside the exhaust pipe, and a downstream end located inside the exhaust pipe at the plurality of flutes.

2. The exhaust ejector tube of claim 1, wherein:
the exhaust pipe has an elbow shape; and
an axial distance from a termination point of the downstream end to a central axis at a first bend is about three times a diameter of the exhaust pipe.

3. The exhaust ejector tube of claim 2, wherein the ejector pipe intersects the exhaust pipe at a distance away from the termination point of the downstream end that is about 1.75 times the diameter of the exhaust pipe.

4. The exhaust ejector tube of claim 3, wherein:
the diameter of the exhaust pipe is about 3-6 inches; and
a diameter of the ejector pipe is about 1-2.5 inches.

5. The exhaust ejector tube of claim 1, wherein the exhaust pipe includes:
a first bend located at the upstream end; and
a second bend located at an intermediate location between the first bend and the downstream end.

6. The exhaust ejector tube of claim 5, wherein:
the first bend has an oblique angle; and
the second bend has an angle of about 90°.

7. The exhaust ejector tube of claim 1, wherein:
the upstream end includes a reducing adapter configured to connect the upstream end to an exhaust system; and
the downstream end is configured to free float within an engine enclosure exhaust stack.

8. An engine system associated with an engine disposed in an enclosure, the engine system comprising:
a pre-cleaner having an inlet, a main outlet configured to communicate with the engine, and a particle outlet;
an engine enclosure exhaust stack open to the enclosure; and
an exhaust ejector tube having:
an exhaust pipe with an upstream end configured to connect to the engine and a downstream end that extends a distance into the engine enclosure exhaust stack, wherein:
the downstream end is annularly spaced apart from the engine enclosure exhaust stack such that a gap exists therebetween; and
the distance that the downstream end of the exhaust pipe of the exhaust ejector tube extends into the engine enclosure exhaust stack is about equal to a diameter of the exhaust pipe;
an ejector pipe that intersects with the exhaust pipe and has a smaller diameter, wherein the gap is about equal to a diameter of the ejector pipe; and
a conduit that extends from the pre-cleaner to the ejector pipe of the exhaust ejector tube.

9. The engine system of claim 8, wherein exhaust flow through the exhaust pipe is sufficient to draw scavenge air and debris through the ejector pipe into the exhaust pipe.

10. The engine system of claim 9, wherein exhaust flow from the exhaust pipe into the engine enclosure exhaust stack is sufficient to draw enclosure air from the enclosure into the engine enclosure exhaust stack.

11. The engine system of claim 8, wherein a plurality of flutes are formed at the downstream end of the exhaust pipe, each of the plurality of flutes have a rounded end that tapers toward the downstream end.

12. The engine system of claim 11, wherein:
the downstream end of the exhaust pipe terminates partway along a length of the plurality of flutes; and
the ejector pipe includes an upstream end located outside the exhaust pipe and a downstream end located inside the exhaust pipe at the plurality of flutes.

13. The engine system of claim 12, wherein:
the exhaust pipe has an elbow shape; and
an axial distance from a termination point of the downstream end to a central axis at a first bend is about three times a diameter of the exhaust pipe.

14. The engine system of claim 13, wherein the ejector pipe intersects the exhaust pipe at a distance away from the termination point of the downstream end that is about 1.75 times the diameter of the exhaust pipe.

15. The engine system of claim 14, wherein:
the diameter of the exhaust pipe is about 3-6 inches; and
a diameter of the ejector pipe is about 1-2.5 inches.

16. The engine system of claim 12, wherein the exhaust pipe includes:
a first bend located at the upstream end; and
a second bend located at an intermediate location between the first bend and the downstream end.

17. The engine system of claim 16, wherein:
the first bend has an oblique angle; and
the second bend has an angle of about 90°.

18. The engine system of claim 8, wherein:
the upstream end includes a reducing adapter configured to connect the upstream end to an exhaust system; and
the downstream end is configured to free float within the engine enclosure exhaust stack.

19. The engine system of claim 8, further including a check valve connected to the particle outlet of the pre-cleaner.

20. A machine, comprising:
a frame;
an engine supported by the frame;
an enclosure supported by the frame and configured to house the engine;
a pre-cleaner extending through the enclosure and having:
an inlet configured to draw in air and debris from the atmosphere;
a first outlet configured to direct a main flow of air to the engine; and
a second outlet configured to discharge a scavenge flow of air and debris;
an engine enclosure exhaust stack connected to the enclosure and configured to receive enclosure air, exhaust gas, scavenge air and debris; and
an exhaust ejector tube having:
an upstream end connected to receive exhaust from the engine;
a downstream end free floating a distance inside the engine enclosure exhaust stack and annularly spaced apart from walls of the engine enclosure exhaust stack by a gap;
a particle inlet configured to receive scavenge air and debris from the second outlet of the pre-cleaner; and
a plurality of flutes located at the downstream end and configured to restrict a flow of exhaust gas from the upstream end to the downstream end, wherein the downstream end terminates at a location partway along a length of the plurality of flutes.
